(19) United States
(12) Patent Application Publication
(10) Pub. No.: US 2023/0055034 A1
(43) Pub. Date: Feb. 23, 2023

(54) NOVEL SOFT CANDY CONTENT AND PRODUCTION PROCESS THEREOF

(71) Applicant: KERVAN GIDA SAN. VE TIC. A.S., Istanbul (TR)

(72) Inventors: Filiz TAZEOGLU, Istanbul (TR); Dilara AKTAY, Istanbul (TR)

(21) Appl. No.: 17/791,992

(22) PCT Filed: Nov. 3, 2020
(86) PCT No.: PCT/TR2020/051038

§ 371 Date: Jul. 11, 2022

(30) Foreign Application Priority Data
Jan. 30, 2020 (TR) 2020/01394
Oct. 14, 2020 (TR) 2020/16399

(51) Int. Cl. A23G 3/44; A23G 3/36; A23G 3/42

(52) U.S. Cl. CPC A23G 3/44; A23G 3/368; A23G 3/42

(57) ABSTRACT

Disclosed are a collagen hydrolyzate added soft candy and production process thereof. The soft candy is rich in collagen and also contains prebiotics. It contains inulin as a prebiotic. Alternatives to collagen hydrolyzate added soft candy are also disclosed. An alternative to the soft candy is in the form containing fish-derived gelatin and collagen hydrolyzate, and an alternative is in a sugar-free form for diabetics. There is also a glucose syrup-free alternative.

### SUBJECT OF THE INVENTION AND TECHNICAL FIELD

The invention relates to a prebiotic and collagen hydrolyzate added soft candy and production process thereof. The prebiotic and collagen hydrolyzate added soft candy of the invention is rich in collagen and also contains prebiotic and Vitamin C. It contains inulin as a prebiotic.

The invention also relates to alternatives to prebiotic and collagen hydrolyzate added soft candy. An alternative to the prebiotic and collagen hydrolyzate added soft candy of the present invention is in the form containing fish-derived gelatin and collagen hydrolyzate, and an alternative is in a sugar-free form for diabetics. There is also a glucose syrup-free alternative.

### STATE OF THE ART

The developing world has affected dietary habits along with living and working conditions. The importance given by the consumers to the relationship between the foods they consume on a daily basis and their health has increased, and this has been accompanied by the tendency to functional food and supplementary foods.

People apply to supplementary foods for the purposes of supplementing normal nutrition, feeling more energetic, strengthening the immune system and meeting the needs of the body in cases where a balanced and healthy diet is not available.

Supplementary foods do not replace natural nutrition, but serve as a complement for its deficiencies, they do not have a purpose to treat or prevent any disease. Supplementary foods are prepared in various forms using nutrients such as vitamins, minerals, proteins, amino acids, herbs, enzymes, fiber and fatty acids. It can be presented to the consumer in tablet, capsule, lozenge, disposable powder package, liquid ampoule, dropper bottle and other similar liquid or powder forms.

The concept of supplementary food can be confused with functional food. Basic method of functional foods is to enrich the foods in terms of vitamins, minerals, fatty acids, antioxidants etc. and strengthen their content for special purposes. Functional foods are not in the forms of pills, tablets, lozenges, etc. and they are enriched and developed foods such as fruits, vegetables, cereals, beverages, etc. The ingredients such as probiotics, prebiotics, omega-3, vitamins and minerals, beta-glucan, beta carotene, lycopene etc. are some of the ingredients used in functional foods. Products such as probiotic yogurts, lactose-free milk, gluten-free foods, gingko and ginseng-containing beverages, omega-3-containing fats, low-calorie foods, low-sodium salts, diabetic foods can be given as examples of functional food class.

Prebiotics are components that enable the intestines to work properly. Due to its durable structure, it cannot be digested by humans and reaches the intestines. It enables beneficial organisms living in the intestinal flora to work. Beneficial living organisms in the intestine are called probiotics. Probiotics grow and develop by feeding on prebiotics.

Probiotics that feed on prebiotics also help other bacteria to multiply. Prebiotic and probiotic fight together to reduce harmful organisms in the intestine. By helping to have healthy intestines, they support weight loss, keep the ideal weight, increase body resistance, and regulate blood sugar.

There are a variety of prebiotics, and the health benefits of 3 different prebiotics have been proven:
Inulin (Long chain inulin)
Short chain fructooligosaccharide (Short chain inulin, FOS), also called oligofructose,
Galactooligosaccharide (GOS)

Inulin and FOS are herbal; GOS is of animal origin. Inulin is found in low amounts in whole grains and certain fruits and vegetables such as asparagus, garlic, and bananas. Long chain inulin leaves a creamy mouthfeel. Thanks to this feature, it can be used as an oil in order to reduce the fat content in products. Short chain inulin (FOS) is sweeter. In order to reduce sugar and some sugar substitutes in food and beverages, it is used instead of them.

On the other hand, we frequently encounter the concept of collagen, which is mostly known from cosmetics and skin care products, which is especially on the agenda of women. Collagen is one of the basic constituent of the human body. The new diet of the modern age has greatly reduced external collagen gain. Not using collagen-rich internal organs and bony meats as often as before, changes in cooking methods, and the replacement of packaged meats, fast food foods, fried foods and grilled foods for animal foods boiled in water at low temperatures for a long time are some of the reasons for this situation.

Collagen is a type of protein found in abundance in the human body. This protein fiber constitutes about a third of all protein in the body. Natural collagen production decreases by 1-1.5% every year from the age of 20. As the self-production of the body decreases, the destruction of existing collagen fibers accelerates, resulting in damage to articular cartilages and tendons, and acceleration of skin wrinkling and sagging.

Collagen is formed by fibroblasts (bond tissue cells) and other cells. A large part of the body bond tissue, such as 80%, consists of collagen. Collagens are found in bones, muscles, forties, skin, tendons, blood vessels and the digestive system. The main function of collagen is to create a network that forms the skin structure by giving strength, flexibility and strength to the skin together with elasticity. It renews dead skin cells, thus increasing the elasticity of the skin and keeping it tight. It can also be thought of as an adhesive that helps the body stay together, connecting joints and tendons. Collagen, which forms bond tissues, protects the skin from toxins and other harmful factors by acting as a protective barrier. It is also an essential component of hair and nails. For this reason, it has a direct effect on nail and hair health.

In supplementary foods, the forms such as capsules, tablets, lozenges, etc. are difficult to consume particularly for the elderly and children. Alternatives such as disposable powder sachets, liquid ampoules, bottles with dropper are not consumable everywhere. Since such presentations give the impression of medicine, they cause patient psychology and are not consumed with pleasure. In this sense, there is a need for a more practical and fondly consumable presentation by leaving the medicine impression.

Soft candies are loved by children and consumed frequently. The advantages of soft candies are that they are easy to consume and practical as well as colorful and in different shapes therefore they gain an attractive feature by appealing to the eye. Besides gelatin, pectin can also be used as a gelling agent in soft candies. Pectin are complex polysaccharides found in the cell wall and intracellular spaces in plants. It is used in the food industry to provide gelation, to thicken, to increase fruit taste, to stabilize the structure, to prevent staling and to provide a homogeneous appearance.

When the developments related to supplements, functional foods, soft candies and the studies on chewable food products were examined separately in the literature, many domestic and foreign patents were found. Apart from these, prebiotic, pectin and collagen concepts were also taken into consideration in our inquiries. Some of the Turkish patents encountered are listed below.

In the patent number 2014/05782, high dietary fiber-prebiotic, tooth-friendly, high calcium chocolate has been developed. Due to the widespread consumption of chocolate, it is aimed to reduce the harmful effects of chocolate on health. Its prebiotic content was effective in facilitating digestion and substituted sweeteners were used by reducing the sugar rate.

In the patent number 2017/11185, a practical and healthy product that provides appetite and weight control, regulates the individual's bowel movements, contributes to the treatment of problems such as constipation, gives a feeling of satiety for a long time, and provides a nutritional supplement to the mother during breastfeeding is the subject. It is a food containing oatmeal, wheat bran, inulin, lentil flour, corn flour, mulberry, flaxseed, apricot, carob, cinnamon, ginger, egg white, germ, barley malt, blueberry, rooibos, fennel, lemon balm, sesame, yeast and honey.

The patent numbered 2019/13110 is “Çiğnenebilir ürün ve bu ürünün yapimina yönelik proses”. The invention relates to a process for making chewable products using substantially dehydrated and/or reinforced complex carbohydrates as the main component. It has been studied with honey as a complex carbohydrate.

The patent number 2016/07897 describes a food concentrate in gel form and a process for the preparation thereof. The said food concentrate can be used to prepare bouillon, soup, sauce or spicy food.

There have also been foreign patents encountered in the state of the art, some of these patents are as follows.

In the Chinese patent, CN108813071 “DHA-rich non-carcinogenic nutritional soft candy and production method thereof” covers a soft candy rich in docosahexenoic acid with nourishing properties and no carcinogenic effect, and production process thereof. It contains isomaltose, pectin, sodium citrate, maltitol, gelatin, algae oil, fruit juice and flavor.

In Chinese patent, CN104957449 “Inulin Jelly” mentions an inulin jelly containing inulin, sodium alginate, gel powder and water. The invention has a variety of beneficial effects on health. It prevents cardiovascular and cerebrovascular diseases, balances blood sugar, positively affects the synthesis of various vitamins and minerals, benefits the intestines and increases immunity.

The Chinese patent CN109566828 “Sugar free soft candy containing various vitamins and preparation method there of” is on a sugar-free soft candy containing pectin with various vitamins. A candy to support nutrition is aimed and especially children are based. It is also thought to prevent tooth decay.

The Canadian patent CA2999313 “Protein Gummy Compositions” is about a protein soft candy content containing sweeteners, plant-based proteins and plant-based gel agents.

The US patent US2017157042 “Gummy Composition for Nutritional Supplementation” is a food supplement study developed in a gummy form. The said invention can be used in diseases and disorders that may occur due to nutritional deficiency during prenatal, pregnancy or breastfeeding periods. It contains vitamins A, B6, B12, B9, C, D, E, B3 and iodine, choline, iron and omega-3 fatty acids. It has a homogeneous and elastic structure and is easily soluble in liquid phase.

In the Korean patent KR101871955 “Composition and method manufacturing jelly collagen casing of sugar-free”, a sugar-free collagen content and production process were studied.

In the Chinese patent CN108157878 “High-fiber calcium reinforced collagen jelly and preparation method thereof”, a high fiber calcium reinforced collagen jelly has been developed.

The German patent DE102011055800 “Use of collagen hydrolyzate for treating and/or preventing cellulite, and as food supplement” has developed a food supplement that will prevent cellulite and/or be used in the treatment thereof with collagen hydrolyzate.

In the state of the art, there are collagen hydrolyzate and prebiotic containing soft candies. However, the amount of collagen corresponding to the portion amount of these products is around 3%, which is quite insufficient. The amount to be taken daily is 2000 mg. Therefore, the amount of soft candy that the consumer should consume in order to get the daily need increases. In this sense, a product with rich collagen content is needed.

### Technical Problems Aimed by the Invention to be Solved

The aim of the invention is to obtain a delicious and easily chewable soft candy containing high content collagen hydrolyzate, prebiotic (inulin) and Vitamin C.

The soft candy of the present invention will provide the required collagen with its high collagen content by consuming a small number of soft candies, and in this way, will solve the problem in the state of the art.

An advantage of the soft candy according to the invention is that it is more practical and enjoyable in terms of consumption compared to the capsule, tablet, lozenge and similar forms in the state of art. At the same time, forms such as capsules, tablets and lozenges create a negative perception in giving the impression of medicine. It can also be difficult to intake by children and individuals with swallowing difficulties. Soft candy form will be a food supplement that can be consumed with pleasure in this sense.

Another advantage of the soft candy of the invention is that it appeals to different consumer groups with different alternatives. An alternative composition is in form containing fish-derived gelatin and collagen hydrolyzate rather than sources such as beef or pork, while another alternative is in sugar-free form for diabetic patients. There is also a glucose syrup-free alternative.

Following figures will be used in order to better understand the soft candy of the invention.

### DESCRIPTION OF THE DRAWINGS

FIG. 1 is a flow chart showing the production steps of soft candy of the invention.

### PROCESS FLOW CHARTS TO SERVE FOR DESCRIBING THE INVENTION

100—The step of mixing collagen hydrolyzate and gelatin in a mixer
110—The step of dissolving the Collagen hydrolyzate-Gelatin powder mixture in water
120—The step of holding Collagen hydrolyzate-Gelatin solution in a mixer
130—The step of mixing Collagen hydrolyzate-Gelatin solution with glucose syrup and
sugar
140—The step of dissolving inulin in water and adding sorbitol
150—The step of combining the collagen hydrolyzate-gelatin solution and inulin-sorbitol solution
160—The cooking step
170—The step of delivering the cooked mixture to the vacuum tank and then to the intermediate tank
180—The step of adding dye, aroma and acid solution to the mixture
190—The step of depositing the products in starch
200—The step of resting and separating from starch stage
210—The oil-coating step
220—The Nitrogen filling-Packaging step

### DETAILED DESCRIPTION OF THE INVENTION

With the soft candy of the present invention, it is aimed to obtain a soft candy that is more nutritious, especially rich in collagen content and with prebiotic properties and can consume with pleasure basically compared to the state of the art. The soft candy of the invention takes its prebiotic property from inulin.

The production method of the soft candy of the invention can be summarized basically as forming a solution by mixing collagen hydrolyzate with gelatin and sorbitol with inulin separately, then mixing these two solutions with sugar and glucose syrup and subjecting to cooking and vacuuming processes. Then, dye, aroma and acid solution are added to the mixture and finally the product is deposited in starch and packaged at the end of resting, separation from starch and oil-coating processes.

When examined in detail the production process of the soft candy according to the invention consists of the following steps.
The step of mixing collagen hydrolyzate and gelatin in a mixer (100)
The step of dissolving the Collagen hydrolyzate-Gelatin powder mixture in water (110)
The step of holding Collagen hydrolyzate-Gelatin solution in a mixer (120)
The step of mixing Collagen hydrolyzate-Gelatin solution with glucose syrup and sugar (130)
The step of dissolving inulin in water and adding sorbitol (140)
The step of combining the collagen hydrolyzate-gelatin solution with the inulin-sorbitol solution (150)
The cooking step (160)
The step of delivering the cooked mixture to the vacuum tank and then to the intermediate tank (170)
The step of adding dye, aroma and acid solution to the mixture (180)
The step of depositing the products in starch (190)
The step of resting and separating from starch stage (200)
The oil-coating step (210)
The Nitrogen filling-Packaging step (220)

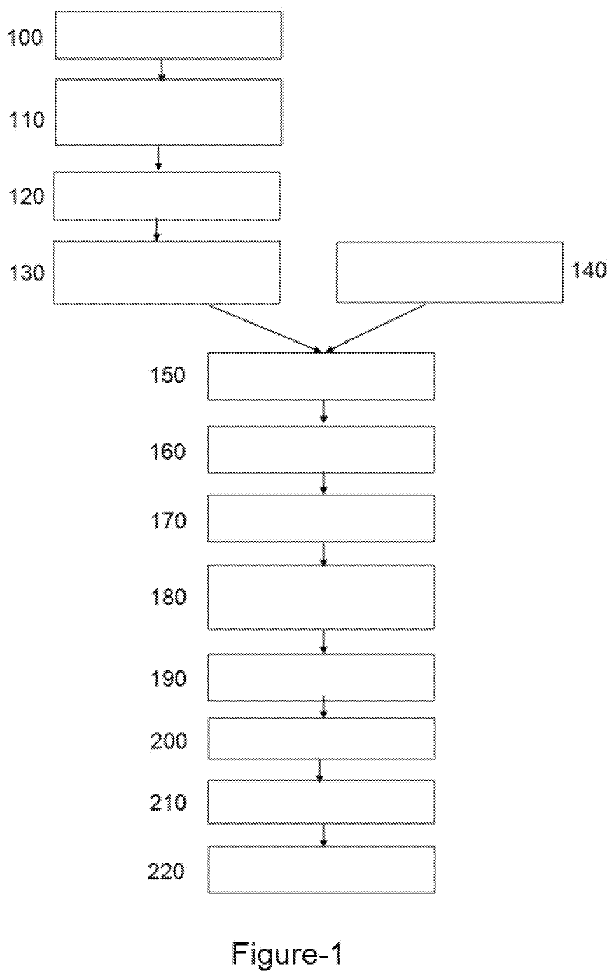

In order to obtain the soft candy according to the invention, the steps mentioned above are carried out. Detailed explanation of these steps is given below. Flow chart for the process is shown in FIG. 1.

The Step of Mixing Collagen Hydrolyzate and Gelatin in a Mixer (100)

In this step, collagen hydrolyzate and gelatin are subjected to mixing process in the mixer for 5-20 min and the mixture is sent to the weighing tank. A manual mixing can be done apart from the mixer, but mixing with a mixer is preferred to ensure homogeneity.

The Step of Dissolving the Collagen Hydrolyzate-Gelatin Powder Mixture in Water (110)

In this step, the powdered collagen hydrolyzate-gelatin mixture is mixed to be dissolved in the range of 10-30% water by weight for 5-20 min. The process takes place in a walled tank and the wall temperature should be in the range of 60-90° C.

The Step of Holding Collagen Hydrolyzate-Gelatin Solution in a Mixer (120)

In this step, the collagen hydrolyzate-gelatin solution prepared in the previous step is sent to another tank. Here, the solution is kept in the range of 0-45 min. The wall temperature of the gelatin intermediate tank should be in the range of 60-90° C.

The Step of Mixing Collagen Hydrolyzate-Gelatin Solution with Glucose Syrup and Sugar (130)

The solution kept in this step is brought to the dough weighing tank with a wall temperature of 60-90° C. It is subjected to the mixing process for 5-20 min by adding glucose syrup and sugar. Mixing is preferably carried out by means of a mixer or similar equipment. Maltitol syrup will be used instead of glucose syrup in this step in the production process of the alternative to the soft candy of the invention for diabetics. In the production process of the glucose syrup-free alternative to the soft candy of the present invention, only sugar will be added in this step.

The Step of Dissolving Inulin in Water and Adding Sorbitol (140)

In this step, the inulin is dissolved in water in the range of 30-60° C. in the inulin solution tank and then mixed for 5-20 min by adding sorbitol and pectin. The amount of water should be in the range of 2-10% by weight. The wall temperature of the inulin intermediate tank should be in the range of 30-65° C. Inulin will not be used in the production of the alternative to the soft candy of the invention for diabetics, so this step will not be carried out.

The Step of Combining the Collagen Hydrolyzate-Gelatin Solution with the Inulin-Sorbitol Solution (150)

In this step, the inulin is dissolved in water with the solution obtained as a result of the step of mixing the Collagen hydrolyzate-Gelatin solution with glucose syrup and sugar (130) and the solution obtained as a result of the step of adding the sorbitol (140) is mixed in the premix intermediate tank for 5-20 min, preferably by means of a mixer or similar mixing equipment. The tank wall temperature should be between 60-90° C. In the production of the alternative to the soft candy of the present invention for diabetics, the solution is taken after the step of mixing the Collagen hydrolyzate-Gelatin solution with glucose syrup and sugar (130) and only sorbitol is added in this step.

The Cooking Step (160)

In this step, the mixture combined in the dough intermediate tank is brought to the cooker and is subjected to the cooking process at a temperature of 105-120° C. for 1-5 min.

The Step of Delivering the Cooked Mixture to the Vacuum Tank and then to the Intermediate Tank (170)

In this step, the cooked mixture is brought to the vacuum tank, preferably with a suction power of 200-600 mm Hg, vacuumed and sent to the intermediate tank.

The Step of Adding Dye, Aroma and Acid Solution to the Mixture (180)

In this step, paint is added to 30-45 kg batches from the mixing intermediate tank and mixed. The mixer may preferably be a mixing equipment to function as a mixer etc. Then the aroma and acid solution are added respectively. During the addition of the aroma and acid solution, the mixer is in the operating state and generally the mixing time is in the range of 5-20 minutes. The acidity balance is achieved by adding the acid solution, and the coloring of the product is made by adding dye. In addition, the Vitamin C content of the soft candy of the invention is added in the form of a solution in this step.

The Step of Depositing the Products in Starch (190)

The mixture obtained in this step is deposited into the spaces in the starch trays, which can be in different shapes, and the printing process of the products takes place. The wall temperature should be in the range of 60-90° C.

The Step of Resting and Separating from Starch Stage (200)

In this step, the printed products are rested for 20-50 hours and separated from starch.

The Oil-Coating Step (210)

In this step, the products that are rested and separated from starch are covered with oil. The coating oil is preferably an oil consisting of waxes such as palm oil, coconut oil, carnauba, and beeswax and used to polish the products and prevent sticking.

The Nitrogen Filling-Packaging Step (220)

In this step, the products covered with oil are filled with nitrogen and packaged.

The basic process steps for the production of the soft candy according to the invention have been detailed above. There are two separate solutions prepared before the step of combining the Collagen hydrolyzate-Gelatin solution with the Inulin-Sorbitol solution (150). These solutions are prepared individually. The following steps may occur before or after the step of dissolving the inulin in water and adding the sorbitol (140) or it may be simultaneous. However, the order of these steps cannot change. The Collagen hydrolyzate-Gelatin mixture obtained as a result of the following four steps is combined with the inulin solution prepared in a separate tank.
The step of mixing collagen hydrolyzate and gelatin in a mixer (100)
The step of dissolving the Collagen hydrolyzate-Gelatin powder mixture in water
The step of holding Collagen hydrolyzate-Gelatin solution (120)
The step of mixing Collagen hydrolyzate-Gelatin solution with glucose syrup and sugar (130)

At the end of the process of the invention, in addition to this basic product, sugar-free soft candy and soft candy alternatives without glucose syrup can be created. Another alternative would be in the form of a soft candy containing fish-derived gelatin instead of sources such as beef or pork.

The percentage amounts by weight of soft candy of the invention and the components of its alternatives are listed below.

TABLE 1
Components of the soft candy according to the invention
and their percentage amounts by weight

| Component | Amount (%) |
|---|---|
| Glycose Syrup | 10-40 |
| Gelatin | 3-15 |
| Pectin | 0-3 |
| Collagen Hydrolyzate | 0-25 |
| Inulin | 0-20 |
| Sugar | 10-40 |
| Sorbitol | 0-10 |
| Vitamin C (Ascorbic acid, sodium ascorbate) | 0-5 |

According to the above table, the soft candy of the invention will contain glucose syrup in the range of 10-40% by weight, gelatin in the range of 3-15%, pectin in the range 0-3%, collagen hydrolyzate in the range 0-25%, inulin between 0-20%, sugar in the range of 10-40%, sorbitol in the range of 0-10% and Vitamin C in the range of 0-5% (Ascorbic acid, sodium ascorbate).

In an alternative to the soft candy of the present invention, sugar and glucose syrup will not be added in the step of mixing the Collagen hydrolyzate-Gelatin solution of the production process with glucose syrup and sugar (130) and isomalt, maltitol syrup and sucralose or stevia will be added to replace the sugar. Also, because of its low sugar content, the step of dissolving inulin in water and adding sorbitol (140) will not be included in this alternative. This sugar-free alternative is suitable for the consumption by people with diabetes. The table showing the components and their percentage amounts by weight of soft candy for people with diabetes is given below.

Compared to the soft candy in Table 1, the gelatin, collagen hydrolyzate, sorbitol and Vitamin C ratios of the soft candy for people with diabetes remain the same and instead of sugar and glucose syrup, 1-20% isomalt and/or 10-70% maltitol syrup, 0.02-0.1% sucralose or stevia sweeteners are used.

TABLE 2
Components of the alternative to the soft candy of the invention
for people with diabetes and their percentage amounts by weight

| Component | Amount (%) |
|---|---|
| Gelatin | 3-15 |
| Pectin | 0-3 |
| Collagen hydrolyzate | 0-25 |
| Sorbitol | 0-10 |
| Isomalt | 1-20 |
| Maltitol Syrup | 10-70 |
| Sucralose or Stevia | 0.02-0.1 |
| Vitamin C (Ascorbic acid, sodium ascorbate) | 0-5 |

As given above, in the soft candy alternative for people with diabetes, gelatin in the range of 3-15%, collagen hydrolyzate in the range of 0-25%, sorbitol in the range of 0-10%, isomalt in the range of 1-20%, maltitol syrup in the range of 10-70%, sucralose or stevia in the range of 0.02-0.1% and Vitamin C in the range of 0-5% will be used.

An alternative to the soft candy of the present invention can be prepared without glucose syrup. The percentage amounts by weight of the soft candy without glucose syrup with their components are listed below. In the soft candy alternative without glucose syrup, compared with Table 1, it appears that glucose syrup has been removed from the composition and pectin and maltodextrin are added. The addition of pectin and maltodextrin occurs in the step of mixing the collagen hydrolyzate-gelatin solution of the production process of the invention with glucose syrup and sugar (130). In this step, glucose syrup will not be used, maltodextrin will be added instead of glucose syrup.

TABLE 3
Components of the alternative without glucose syrup to the soft
candy of the invention and their percentage amounts by weight

| Component | Amount (%) |
|---|---|
| Gelatin | 3-15 |
| Collagen Hydrolyzate | 0-25 |
| Sugar | 10-40 |
| Pectin | 0-3 |
| Maltodextrin | 10-50 |
| Inulin | 0-20 |
| Sorbitol | 0-10 |
| Vitamin C (Ascorbic acid, sodium ascorbate) | 0-5 |

As given in Table 3, in soft candy without glucose syrup, gelatin in the range of 3-15% by weight, collagen hydrolyzate in the range of 0-25%, sugar in the range of 10-40%, pectin in the range of 0-3%, maltodextrin in the range of 10-50%, inulin in the range of 0-20%, sorbitol in the range of 0-10% and Vitamin C in the range of 0-5% will be used. Another alternative to a soft candy containing fish-derived gelatin instead of sources such as beef or pork may also be created.

The percentage amounts by weight of the soft candy containing fish-derived gelatin with their components are listed below.

For people who do not want to consume beef or pork-derived components, the difference of alternative soft candy from the basic content in Table 1 is the use of fish-derived gelatin and collagen hydrolyzate. The addition of pectin will take place in the production process of the soft candy of the invention “in the step of dissolving inulin in water and adding sorbitol (140)”.

TABLE 4
Components of the fish-derived alternative to the soft candy
of the invention and their percentage amounts by weight

| Component | Amount (%) |
|---|---|
| Glycose Syrup | 10-40 |
| Sugar | 10-40 |
| Fish-derived gelatin | 3-15 |
| Fish-derived collagen hydrolyzate | 0-25 |
| Sorbitol | 0-10 |
| Pectin | 0-3 |
| Inulin | 0-20 |
| Vitamin C (Ascorbic acid, sodium ascorbate) | 0-5 |

As given in the table above, in the fish-derived soft candy, glucose syrup in the range of 10-40% by weight, sugar in the range of 10-40%, fish-derived collagen hydrolyzate in the range of 0-25%, fish-derived gelatin of in the range of 3-15%, pectin in the range of 0-3%, inulin in the range of 0-20%, and Vitamin C (Ascorbic acid, sodium ascorbate) in the range of 0-5% will be used.

The soft candy and three different alternatives obtained at the end of the process of the invention are a product which of content can be consumed by all ages in a pleasant and entertaining way that appeals to different audiences. At the same time, thanks to its high protein content, it has a nutritional value and helps to provide the amount of collagen needed daily, while it is beneficial for probiotics and intestines with its prebiotic (inulin). The soft candy of the invention can be colored by using natural or artificial colorants in the step of adding dyes, aroma, and acid solution to the mixture (180) in the production process and can also be flavored with different natural or artificial flavors. Different ways of presentations can be provided by using different molds “in the step of depositing products in starch (190)”.

### INDUSTRIAL APPLICABILITY OF THE INVENTION

The soft candy of the invention and its alternative compositions are a product to be produced by packaging a certain amount. The said soft candy and its alternative compositions can be consumed at any time of the day without restriction on portion sizes.

1. A production process of a novel soft candy, wherein the process includes the following steps:
mixing collagen hydrolyzate and gelatin in a mixer (100);
dissolving the Collagen hydrolyzate-Gelatin powder mixture in water (110);
holding Collagen hydrolyzate-Gelatin solution in a mixer (120);
mixing Collagen hydrolyzate-Gelatin solution with glucose syrup and sugar (130);
dissolving inulin in water and adding sorbitol (140);
combining the collagen hydrolyzate-gelatin solution with the inulin-sorbitol solution (150);
cooking step (160);
delivering the cooked mixture to a vacuum tank and then to an intermediate tank (170);
adding dye, aroma and acid solution to the mixture (180);
depositing the products in starch (190);
resting and separating from starch stage (200);
an oil-coating step (210); and
a Nitrogen filling-Packaging step (220).

2. A production process according to claim 1, wherein the step of mixing gelatin with collagen hydrolyzate (100) comprises mixing collagen and gelatin for 5-20 min, by means of a mixer or similar mixing equipment, and delivering the mixture to the weighing tank.

3. A production process according to claim 1, wherein the step of dissolving collagen hydrolyzate-gelatin powder mixture in water (110) comprises dissolving the collagen-gelatin mixture within water in range of 10-30% within a weighing tank with a wall temperature of 60-90° C. for 5-20 min, by mixing by means of a mixer of similar equipment.

4. A production process according to claim 1, wherein the step of holding the collagen-gelatin solution (120) comprises bringing the collagen hydrolyzate-gelatin solution prepared in the previous step into the gelatin intermediate tank with a wall temperature of 60-90° C., and holding the solution for 0-45 min.

5. A production process according to claim 1, wherein the step of mixing the collagen hydrolyzate-gelatin solution with glycose syrup and sugar (130) comprises bringing the solution held in the previous step into the gelatin intermediate tank with a wall temperature of 60-90° C. and adding sugar and mixing for 5-20 min, with a mixer or similar mixing equipment.

6. A production process according to claim 5, wherein the step of mixing collagen hydrolyzate-gelatin solution with glucose syrup and sugar for a glucose syrup-free alternative product (130) comprises adding only sugar to the collagen hydrolyzate-gelatin solution.

7. A production process according to claim 5, wherein the step of mixing collagen hydrolyzate-gelatin solution with glucose syrup and sugar for alternative product for people with diabetes (130) comprises using maltitol syrup instead of glucose syrup.

8. A production process according to claim 1, wherein the step of dissolving inulin in water and adding sorbitol (140) comprises dissolving the inulin solution within the inulin solution tank with wall temperature between 30-65° C. in 2-10% by weight of water in the range of 30-60° C., and then adding sorbitol and pectin and mixing for 5-20 min, by means of a mixer or similar mixing equipment.

9. A production process according to claim 7, wherein it may be carried out, in the step of dissolving the inulin in water and adding sorbitol (140), before, after, or simultaneously with the following steps.
the step of mixing collagen and gelatin in a mixer (100);
the step of dissolving the Collagen hydrolyzate-Gelatin powder mixture in water (110);
the step of holding Collagen hydrolyzate-Gelatin solution in a mixer (120);
the step of mixing Collagen hydrolyzate-Gelatin solution with glucose syrup and sugar (130).

10. A production process according to claim 1, wherein the step of combining the inulin-sorbitol solution with the collagen-gelatin solution (150) comprises dissolving inulin in water with the solution as a result of mixing Collagen hydrolyzate-Gelatin solution with glucose syrup and sugar (130), and mixing the solution formed as a result of the step of adding sorbitol (140) in a dough intermediate tank with a wall temperature of 60-90° C. for 5-20 min, by means of a mixer or similar mixing equipment.

11. A production process according to claim 10, wherein the step of combining the inulin-sorbitol solution with the collagen hydrolyzate-gelatin solution for an alternative product for people with diabetes (150) comprises removing the solution after the step of holding the collagen hydrolyzate-gelatin solution (120) and only adding sorbitol.

12. A production process according to claim 1, wherein the cooking step (160) comprises bringing the mixture combined in the dough intermediate tank into the cooker and subjecting to the cooking process for 1-5 min at the temperature in the range of 105-120° C.

13. A production process according to claim 1, wherein the step of delivering the cooked mixture to the vacuum tank and then to the intermediate tank (170) comprises vacuuming the cooked mixture in the vacuum tank with a suction power of 200-600 mm and delivering to the intermediate tank.

14. A production process according to claim 1, wherein the step of adding dye, aroma and acid solution to the mixture (180) comprises delivering the mixture from the intermediate tank to the gravomat, adding dye to the batches and mixing them, by means of a mixing equipment to function as a mixer, adding flavor and acid solution respectively while the mixer is in the operating state and incorporating Vitamin C to the process together with the acid solution, wherein the mixing step generally takes for 5-20 min.

15. A production process according to claim 1, wherein the step of depositing the products in starch (190) comprises depositing the mixture obtained in a medium with a wall temperature of 60-90° into the spaces in the starch trays in different shapes and printing.

16. A production process according to claim 1, wherein the step of resting and separating from the starch (200) comprises resting the printed products for 20-50 hours.

17. A production process according to claim 1, wherein the oil-coating step (210) comprises coating the rested products with oil, wherein preferably the coating oil is an oil, consisting of waxes such as palm oil, coconut oil, carnauba, and beeswax.

18. A production process according to claim 1, wherein the nitrogen filling packaging step (220) comprises filling the oil-coated products with nitrogen and packaging.

19. A novel soft candy content, wherein the soft candy includes collagen hydrolyzate in the range 0-25% by weight, glucose syrup in the range of 10-40%, gelatin in the range of 3-15%, pectin in the range of 0-3%, inulin in the range of 0-20%, sugar in the range of 10-40%, sorbitol in the range of 0-10% and Vitamin C in the range of %0-5.

20. A soft candy according to claim 19, wherein an alternative for people with diabetes includes collagen hydrolyzate in the range 0-25%, gelatin in the range of 3-15%, pectin in the range of 0-3%, sorbitol in the range of 0-10%, isomalt in the range of 1-20%, maltitol syrup in the range of 10-70%, sucralose or stevia in the range of 0.02-0.1% and Vitamin C in the range of %0-5.

21. A soft candy according to claim 19, wherein an alternative without glycose syrup includes collagen hydrolyzate in the range 0-25%, gelatin in the range of 3-15%, sugar in the range of 10-40%, pectin in the range of 0-3%, maltodextrin in the range of 10-50%, inulin in the range of 0-20%, sorbitol syrup in the range of 0-10% and Vitamin C in the range of %0-5.

22. A soft candy according to claim 19, wherein a fish-derived alternative includes fish-derived collagen hydrolyzate in the range 0-25%, sorbitol in the range of 0-10%, glycol syrup in the range of 10-40%, sugar in the range of 10-40%, fish-derived gelatin in the range of 3-15%, pectin in the range of 0-3%, inulin in the range of 0-20% and Vitamin C in the range of %0-5.
